(19) United States
(12) Patent Application Publication
(10) Pub. No.: US 2008/0254667 A1
(43) Pub. Date: Oct. 16, 2008

(54) Electrical Connector

(76) Inventor: Gary Barnett, Leicestershire (GB)

Correspondence Address: BARLEY SNYDER, LLC, 1000 WESTLAKES DRIVE, SUITE 275, BERWYN, PA, 19312, US

(21) Appl. No.: 11/815,527

(22) PCT Filed: Jan. 27, 2006
(86) PCT No.: PCT/GB2006/050022

§ 371 Date: Aug. 3, 2007

(30) Foreign Application Priority Data
Feb. 4, 2005 (GB) 0502319.7

(51) Int. Cl. H01R 13/62

(52) U.S. Cl. 439/321

(57) ABSTRACT

An electrical connector comprising a connector body defining a socket for receiving an electrical conductor, a fastener mounted within the socket and engaged with a thread of an internal surface of the connector body so that rotation of the fastener relative to the connector body along a longitudinal axis of the socket causes movement of the fastener between a first position in which the socket is able to receive the electrical conductor and a second position in which the fastener fastens the electrical conductor within the socket, and a drive component rotatably mounted to the connector body and configured to engage the fastener such that rotation of the drive component with respect to the connector body causes rotation movement of the fastener between the first position and the second position is disclosed.

This invention relates to electrical connectors, in particular (though not exclusively) to electrical connectors for use with electrical power distribution cables.

The distribution of electrical power within the United Kingdom involves distribution networks operating at a number of particular voltages. Power is distributed from power stations at very high voltages, typically 400 kV, 275 kV or 132 kV, via overhead power lines. Further distribution then takes place through networks operating at voltages typically between 1 kV and 50 kV, and principally at a voltage of 11 kV or 33 kV, before the electricity is finally supplied to consumers at normal “mains” voltages of 240V (single-phase) or 415V (three-phase).

Cables operating at the intermediate voltage range, eg 11 kV or 33 kV, are commonly installed underground. From time to time, it is necessary for joints to be created in such cables, either for maintenance purposes or to create branch connections or the like. Among the problems that are encountered in creating such joints are that the cables may be of relatively large diameter and hence may be inflexible and difficult to manipulate. These problems may be exacerbated by the environment in which the cables are installed (eg underground chambers or ducting) or the confines of a trench excavated around the cable.

Conventionally, one form of electrical connector that has been used for the end-to-end connection of two electrical conductors in such circumstances comprises a cylindrical body having blind bores at each end into which the conductor ends are inserted. Threaded bores are provided in the wall of the cylindrical body for bolts to secure the conductors.

Known connectors of this type suffer from a number of disadvantages. For example, conventional bolt connectors require a threaded bore in the wall of the connector for a clamping bolt, and hence necessarily have a substantially greater cross-sectional dimensions that those of the conductor. In addition, many conventional bolt connectors are arranged such that conductors engaged therewith are displaced from the centre line of the connector. This creates increased electrical stress when voltage is applied and can lead to difficulty in achieving effective insulation about the connector. Finally, the exterior surface of many conventional connectors include protrusions and/or sharp edges that promote undesirable electrical discharges from the connector.

There has now been devised an improved electrical connector which overcomes or substantially mitigates the above-mentioned and/or other disadvantages associated with the prior art.

According to a first aspect of the invention, there is provided an electrical connector comprising a connector body defining a socket for receiving an electrical conductor, and a fastening member for fastening the electrical conductor within the socket, the fastening member being mounted within the socket, and being movable along the longitudinal axis of the socket from a first position in which the socket is able to receive the electrical conductor, to a second position in which the fastening member fastens the electrical conductor within the socket.

The electrical connector according to the invention is advantageous over the prior art principally because the electrical connector may be formed with a reduced diameter relative to conventional bolt connectors because the need for a threaded bore in the wall of the connector for a clamping bolt is removed. Moreover, the form of the fastening member may be such that the electrical conductor is secured co-axially within the socket, improving the electrical properties of the connection, and the connector may be formed so that it has a generally smooth overall external shape, which is free from protrusions and sharp edges, once the conductor has been fastened within the socket. This feature eliminates or reduces the risk of electrical discharges occurring from the connector.

Preferably, at least part of the internal surface of connector body that defines the socket includes a thread for engagement with the fastening member such that rotation of the fastening member relative to the connector body causes movement of the fastening member along the longitudinal axis of the socket. The exterior surface of the fastening member therefore preferably has a corresponding thread.

The connector according to the invention preferably further comprises a drive component for effecting movement of the fastening member relative to the connector body from the first position to the second position. The drive component is preferably rotatably mounted relative to the connector body, for example by means of cooperating formations on the drive component and the connector body, such that rotation of the drive component causes the fastening member to move along the longitudinal axis of the socket. Preferably, a part of the drive component that extends into the socket has formations that cooperate with other formations on the internal wall of the socket. In presently preferred embodiments, the drive component is rotatably mounted to the connector body by means of one or more projections on the external surface of the drive component that cooperate with an annular groove formed in the internal surface of the connector body. The drive component preferably includes means for engagement with a suitable tool, such as a spanner. In order to minimise protrusions and sharp edges at the external surface of the connector, such means preferably take the form of one or more recesses.

The drive component preferably comprises means for engaging the fastening member such that rotation of the drive component causes rotation of the fastening member, and hence movement of the fastening member along the longitudinal axis of the socket between the first and second positions. Such means preferably comprises a projection having a non-circular cross-section that is received within a correspondingly-shaped recess of the fastening member. The drive component preferably includes an opening through which the electrical conductor is inserted before it is received within the socket. Most preferably, the drive component comprises a central bore having cross-sectional dimensions that match those of the inner portion of the socket and a bore of the fastening member in its first position. In this case, the bores of the drive component and the fastening member, and the inner portion of the socket, are preferably all in registration with one another before the electrical conductor is received by the socket, and thereby form a cavity for receiving the electrical conductor.

The connector body of the electrical connector according to the invention preferably has a generally smooth overall external shape, which is free from protrusions and sharp edges, once the conductor has been fastened within the socket. In particular, the connector body preferably has a circular or elliptical external cross-sectional shape, and is most preferably generally cylindrical in form.

Means are preferably provided by which a suitable tool may engage the connector body so that the connector body can be held stationary and/or be rotated by a user during fastening of the conductor within the socket. Such means are preferably formations suitable for engagement by a suitable tool, such as a spanner. In order that the connector body has a generally smooth overall external shape, once the conductor has been secured to the connector, the part of the connector body that carries such formations may be removed after the conductor has been secured. For example, such formations may be formed on a head that is adapted to shear from the connector body when a pre-determined torque is applied to the head relative to the connector body.

The socket preferably comprises means for guiding or deforming at least part of the fastening member into engagement with the electrical conductor, as the fastening member moves from the first position to the second position, so as to fasten the electrical conductor within the socket. Most preferably, the fastening member is deformable, and the socket is configured to deform at least part of the fastening member into engagement with the electrical conductor, as the fastening member moves from the first position to the second position, so as to fasten the electrical conductor within the socket. In particular, the socket preferably includes a region of reduced cross-sectional area that acts to deform at least part of the fastening member into engagement with the electrical conductor.

In preferred embodiments, the socket comprises an outer portion, and an inner portion of reduced cross-sectional area relative to the outer portion. In this case, the interior surface of the connector body that defines the inner portion of the socket preferably defines, together with the electrical conductor, a cavity that receives at least part of the fastening member, in use, so as to fasten the electrical conductor within the socket by frictional engagement.

In preferred embodiments, the inner and outer portions of the socket each have a constant cross-sectional area. In order to facilitate entry of the fastening member into said cavity, the socket preferably includes a tapered shoulder between the inner and outer portions. In addition, the fastening member preferably decreases in thickness as it extends in the direction of the inner portion of the socket. In this way, the thickness of the fastening member at the entrance to the inner portion will increase as the fastening member is inserted further into said cavity until the electrical conductor is fastened within the socket by frictional engagement. This enables conductors having any of a range of different diameters to be fastened within the socket.

Preferably, the fastening member extends about the circumference of the electrical conductor when the conductor has been fastened within the socket. This enables the conductor engaged with the connector to be located centrally relative to the socket and hence also the remainder of the connector. The electrical field properties of the completed connection are thereby improved, making the completed connection easier to insulate. This is particularly important when connecting electrical cables that operate at the intermediate voltage range of power distribution networks, eg at 11 kV or 33 kV.

In presently preferred embodiments, the fastening member has the form of a sleeve. Preferably, the fastening member has a bore for receiving the electrical conductor, the bore preferably having cross-sectional dimensions that match those of the inner portion of the socket. The bore of the fastening member is preferably in registration with the inner portion of the socket before the conductor has been fastened within the socket. The external surface of the part of the fastening member that, in use, extends into the inner portion of the socket, is preferably frusto-conical in form.

The electrical connector may be an end termination connector for attaching the conductor to another component, and which typically comprises a single socket, or a jointing connector for connecting two conductors together, which typically comprises two or more sockets that are each adapted to have an electrical conductor fastened therewithin. The electrical conductor received by the socket of the connector may by a solid or stranded conductor, depending upon the application.

Where the electrical connector is a jointing connector, the connector may comprise a single connector unit having two or more sockets formed therein. For example, such a jointing connector could be in the form of a substantially straight article having a socket according to the present invention at each of its ends. Alternatively, the connector may comprise two or more connector units, each with one or more sockets. In this case, the two or more connector units are preferably adapted to be connected together so as to form an electrical connection between electrical conductors fastened within the sockets of the connector units.

The connector body and the fastening member are preferably formed of a suitably electrically conductive material, such as copper, aluminium, or alloys thereof. The connector body may be enclosed by an insulating sheath.

The electrical connector according to the invention preferably forms part of an electrical power distribution network. However, the electrical connector could also be configured for use in many other types of electrical networks, such as an electrical network in a building. The electrical connector according to the invention is particularly advantageous for use with cables of an electrical power distribution network that operate at voltages of between 1 kV and 50 kV, eg 11 kV or 33 kV.

According to a further aspect of the invention, there is provided a method of fastening an electrical conductor within a socket of an electrical connector, which method comprises the steps of

(a) providing an electrical connector according to the first aspect of the invention;

(b) inserting the electrical conductor into the socket of the electrical connector; and

(c) causing the fastening member of the electrical connector to move along the longitudinal axis of the socket from the first position to the second position so as to fasten the electrical conductor within the socket.

Preferably, movement of the fastening member along the longitudinal axis of the socket is effected by rotation of the fastening member relative to the connector body. Where the connector according to the invention comprises a drive component for effecting movement of the fastening member relative to the connector body from the first position to the second position, rotation of the drive component relative to the connector body preferably causes the fastening member to move along the longitudinal axis of the socket.

Rotation of the drive component relative to the connector body is preferably achieved by engagement of formations of the drive component and the connector body with suitable tools, such as spanners. Most preferably, once the electrical conductor has been fastened within the socket, that part of the connector body that carries formations suitable for engagement by a suitable tool is removed. In preferred embodiments, a head that carries such formations is sheared from the connector body when a pre-determined torque is applied to the head relative to the remainder of the connector body.

According to a further aspect of the invention, there is provided an electrical power distribution cable including a connection comprising an electrical connector as described above. Preferably, such a cable operates at a voltage of between 1 kV and 50 kV, eg 11 kV or 33 kV.

The invention will now be described in greater detail, by way of illustration only, with reference to the accompanying drawings, in which

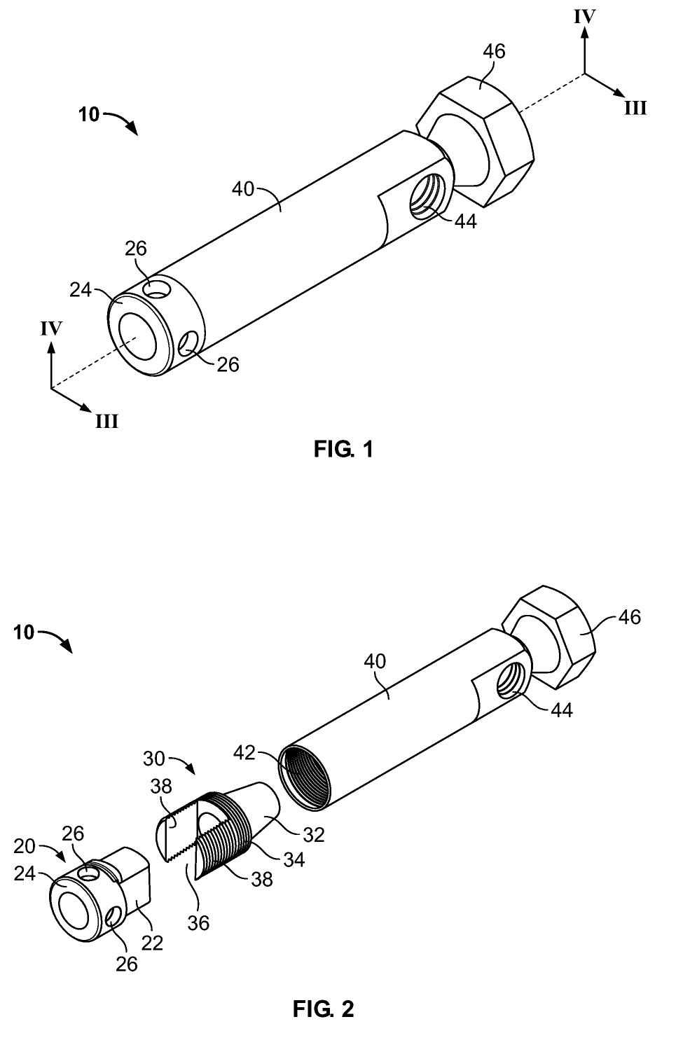

FIG. 1 is a perspective view of a first embodiment of an electrical connector according to the invention;

FIG. 2 is an exploded perspective view of the first embodiment;

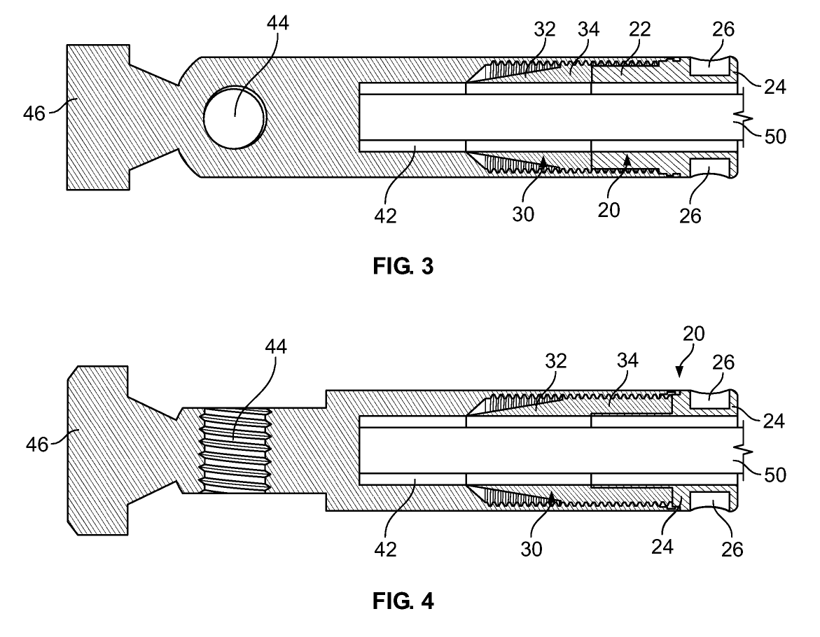

FIG. 3 is a cross-sectional view, along line III-III in FIG. 1, of the first embodiment with an electrical conductor inserted into a socket of the connector, but prior to securing of the conductor within the socket;

FIG. 4 is a cross-sectional view, along line IV-IV in FIG. 1, of the first embodiment with an electrical conductor inserted into a socket of the connector, but prior to securing of the conductor within the socket;

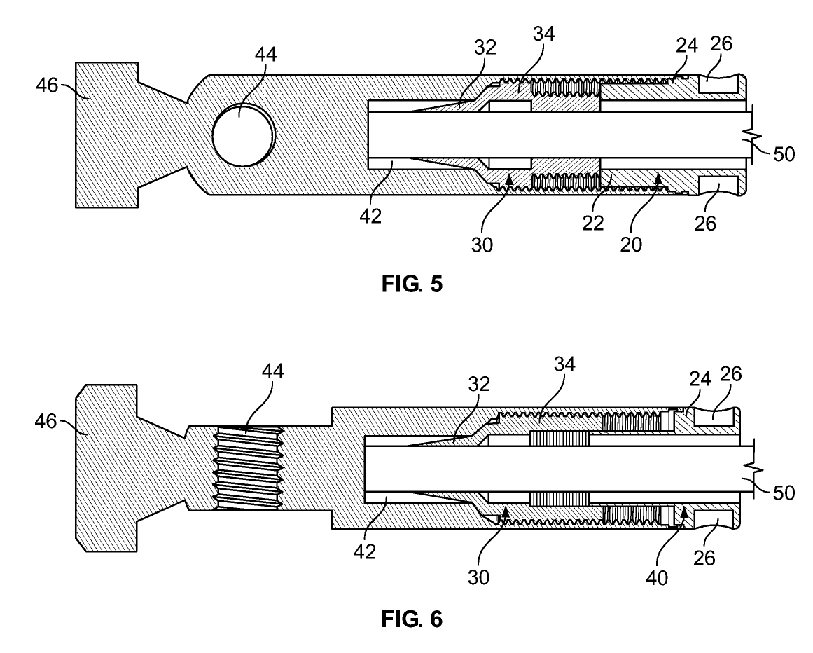

FIG. 5 is a cross-sectional view, along line III-III in FIG. 1, of the first embodiment with an electrical conductor fastened within a socket of the connector;

FIG. 6 is a cross-sectional view, along line IV-IV in FIG. 1, of the first embodiment with an electrical conductor fastened within a socket of the connector;

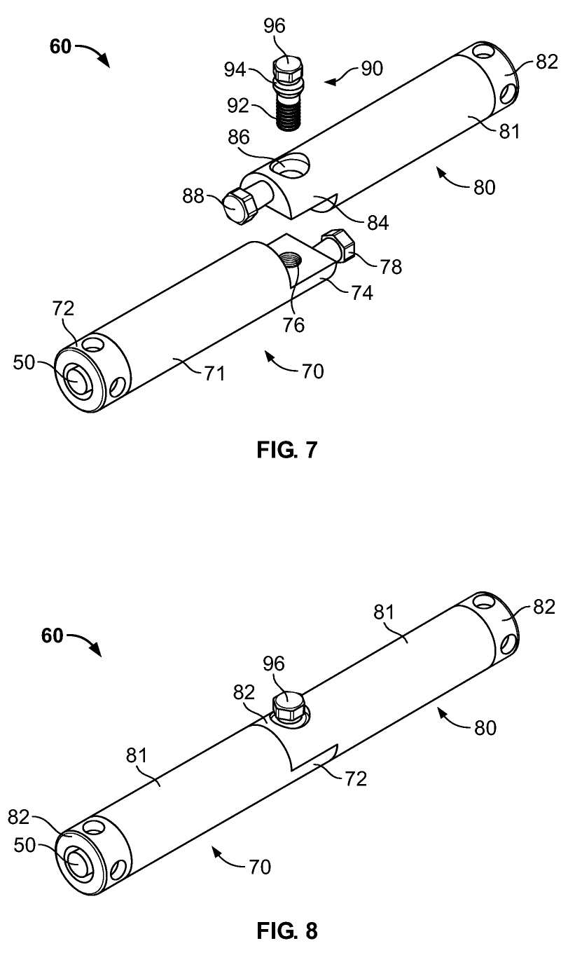

FIG. 7 is a perspective view of a second embodiment of an electrical connector according to the invention in an unconnected configuration; and

FIG. 8 is a perspective view of the second embodiment in a connected configuration.

FIGS. 1 and 2 show a first embodiment of an electrical connector according to the invention, which is generally designated 10. The electrical connector 10 is an “end termination” connector for connecting one end of an electrical conductor to another component of an electrical power distribution network. The electrical connector 10 comprises a drive component 20, a fastener 30, and a connector body 40 defining a socket 42. Each of these components 20,30,40 of the electrical connector 10 is formed of a suitable electrically conductive material, such as copper, aluminium, or alloys thereof.

FIGS. 3 and 4 each illustrate the electrical connector 10 with a cylindrical electrical conductor 50 inserted into the socket 42 of the connector body 40 but prior to securing of the conductor 50 within the socket 42.

Referring to FIGS. 1 to 4, the connector body 40 is generally cylindrical in form with a shearable head 46 projecting from one end of the connector body 40. The socket 42 comprises an entrance aperture at the end of the connector body 40 that is remote from the shearable head 46, and extends co-axially towards, but terminates a distance before, the other end of the connector body 40. The portion of the connector body 40 between the socket 42 and the end of the connector body 40 from which the shearable head 46 extends has an external surface that includes a pair of opposed flat portions, and comprises a threaded bore 44 that extends between these flat surface portions. The threaded bore 44 is orientated orthogonally relative to the socket 42, and enables the connector 10 to be fastened to another component of an electrical power distribution network.

The socket 42 of the connector body 40 comprises an outer cylindrical portion, that is connected via a tapered shoulder to an inner cylindrical portion of reduced diameter.

The interior surface of the connector body 40 that defines the outer cylindrical portion of the socket 42 is threaded for engagement with the fastener 30, save for an end portion immediately adjacent to the entrance of the socket 42 that comprises a continuous annular groove for engagement with the drive component 20.

The shearable head 46 comprises a head of hexagonal cross-section, which is suitable for engagement with a conventional spanner, and a frusto-conical neck that connects the head to the connector body 40. The end of the neck that is adjacent to the connector body 40 is of reduced diameter, and hence weakened, relative to the connector body 40 and the other end of the neck, and thereby defines a shear plane. The shearable head 46 is therefore adapted to shear from the connector body 40 at this shear plane when a pre-determined torque is applied to the shearable head 46 relative to the connector body 40.

The fastener 30 comprises a threaded portion 34 adapted to engage with the interior surface of the connector body 40 that defines the outer cylindrical portion of the socket 42, and a deformable portion 32 extending therefrom.

The deformable portion 32 has a central bore extending therethrough. The bore is cylindrical and has a diameter that matches the diameter of the inner cylindrical portion of the socket 42. The external shape of the deformable portion 32 is frusto-conical such that the deformable portion 32 reduces in external diameter as it extends away from the threaded portion 34. Since the bore of the deformable portion 32 is cylindrical in form, the wall of the deformable portion 32 also reduces gradually in thickness as it extends away from the threaded portion 34.

The threaded portion 34 of the fastener 30 is generally cylindrical but with a substantial part cut away to form a slot 36 bounded by a pair of arms 38. The inner surfaces of the arms 38 are flat and are parallel to each other, and together define the slot that receives part of the drive component 20. The external thread of the threaded portion 34 of the fastener 30 engages the internal thread of the connector body 40, such that rotation of the fastener 30 moves the fastener 30 along the longitudinal axis of the socket 42.

Before the conductor 50 is fastened within the connector 10, the fastener 30 is situated entirely within the outer cylindrical portion of the socket 42, with the tip of the deformable portion 32 situated at the tapered shoulder of the socket 42, adjacent to the entrance to the inner cylindrical portion of the socket 42.

The drive component 20 comprises a main body 24 and a lug 22 extending therefrom that engages the fastener 30. A bore extends along the longitudinal axis of the drive component 20. This bore has a diameter that matches both the diameter of the central bore of the fastener 30 and the diameter of the inner cylindrical portion of the socket 42.

The main body 24 of the drive component 20 is generally cylindrical, and includes four equiangularly-spaced recesses in its external surface. Each recess has a circular cross-section, and each recess is adapted so as to be engageable by a “C” spanner. A “C” spanner has a curved head with a tooth at one end, the tooth being engageable with one of the recesses of the drive component 20.

The external diameter of the main body 24 matches that of the connector body 40, save for a portion of the main body 24 that is immediately adjacent to the lug 22. This portion of the main body 24 has a reduced diameter so as to be received within the socket 42, and includes a pair of part-circumferential ribs that engage with the annular groove in the interior surface of the connector body 40 such that the drive component 20 is engaged with, and rotatable relative to, the connector body 40.

The lug 22 of the drive component 20, a pair of opposed faces of which are flat, is received in the slot 36, between the arms 38 of the fastener 30. The lug 22 is therefore located between the arms 38 of the fastener 30 with a relatively close fit such that rotation of the drive component 20 using a suitable tool causes rotation of the fastener 30.

The central bores of the fastener 30 and the drive component 20, and the inner cylindrical portion of the socket 42, are all in registration with one another so as to form a cylindrical cavity for receiving the electrical conductor 50. The electrical conductor 50 is inserted, in use, through the central bores of the drive component 20 and the fastener 30, and into the inner cylindrical portion of the socket 42.

In order to secure the conductor 50 within the socket 42 of the connector 10, the shearable head 46 is engaged and held stationary using a conventional spanner, and the drive component 20 is engaged and rotated relative to the connector body 40 and shearable head 46 using a “C” spanner. Alternatively, the drive component 20 may be engaged and held stationary, and the shearable head 46 engaged and rotated relative to the drive component 20.

Rotation of the drive component 20 relative to the connector body 40 causes rotation of the fastener 30 relative to the connector body 40, as discussed above, such that the fastener 30 is displaced along the longitudinal axis of the connector body 40 towards the inner cylindrical portion of the socket 42.

As the fastener 30 moves towards the inner cylindrical portion of the socket 42, the deformable portion 32 of the fastener 30 bears against the tapered shoulder, and is deformed inwardly, and guided into the annular cavity between the external surface of the conductor 50 and the interior surface of the connector body 40 that defines the inner cylindrical portion of the socket 42.

Further rotation of the drive component 20 relative to the connector body 40 will cause the deformable portion 32 of the fastener 30 to extend further into the annular cavity. Since the wall of the deformable portion 32 increases gradually in thickness towards the threaded portion 34, the thickness of the deformable portion 32 at the entrance to the annular cavity will increase as the drive component 20 is rotated further. This will continue until the thickness of the deformable portion 32 at the entrance to the annular cavity equals the thickness of the annular cavity.

This configuration is shown in FIGS. 3 and 4. Continued rotation of the drive component 20 will urge the deformable portion 32 of the fastener 30 further into the annular cavity, which will cause a torque to be imparted, by means of frictional engagement, on the connector body 40 by the fastener 30. This torque will increase on further rotation of the fastener 30 until the torque exerted by the fastener 30 on the connector body 40 causes the shearable head 46 to shear from the connector body 40. The conductor 50 is now securely clamped within the socket 42 by the fastener 30.

FIGS. 7 and 8 show a second embodiment of an electrical connector according to the invention, which is generally designated 60. The second embodiment 60 is a jointing connector for connecting two conductors 50 together, and comprises first and second connector units 70,80. Each connector unit 70,80 has a similar arrangement to the connector 10 of the first embodiment, and hence comprises a drive component 72,82, a fastener (not visible in FIGS. 7 and 8), and a connector body 71,81 defining a socket.

As in the first embodiment 10, shearable heads 78,88 project from the ends of the connector bodies 71,81 of each connector unit 70,80 that are remote from the open ends fo the sockets. In contrast to the first embodiment 10, however, the end parts of the connector bodies 71,81 from which the shearable heads 78,88 project are formed as hemi-cylindrical palms 74,84. The dimensions of the palms 74,84 are such that, after the shearable heads 78,88 have been removed, the palms 74,84 may be brought together to form the assembled connector of cylindrical overall form.

Each of the palms 74,84 has a bore 76,86 formed therein. The bore 86 of the second connector unit 80 is a plain bore with a shoulder near its upper end, and the bore 76 of the first connector unit 70 is threaded.

The second embodiment 60 further comprises a securing bolt 90. The securing bolt 90 has a shank 92 that is threaded for the majority of its length, and an enlarged head forming a shoulder 94. A drive head 96 of hexagonal cross-section is attached to the head 94 by a neck of reduced dimension.

Each conductor 50 is fastened within the socket of a connector unit 70,80 in an identical manner to that with which a conductor 50 is fastened within the socket 42 of the first embodiment 10. In particular, the electrical conductor 50 is inserted through the central bores of the drive component 72,82 and the fastener, and into the inner cylindrical portion of the socket. The shearable head 78,88 is engaged using a conventional spanner, the drive component 72,82 is engaged using a “C” spanner, and the drive component 72,82 is rotated relative to the connector body 71,81. This causes the fastener to engage and fasten the conductor 50 within the socket of the connector unit 70,80, and finally causes the shearable head 78,88 to shear from the connector body 40.

Once each conductor 50 has been fastened within the socket of a connector unit 70,80, the connector units 70,80 are fastened together, as shown in FIG. 8. In particular, the flat surfaces of the palms 74,84 of the connector units 70,80 are brought together so that the plain bore 86 and the threaded bore 76 are brought into registration, and the connector bodies 71,81 of the connector units 70,80 are aligned so as to form a cylindrical connection.

The securing bolt 90 is then inserted into the plain bore 86 and its threaded shank 92 engaged with the threaded bore 76. Rotation of the bolt 90 (by means of a suitable tool applied to the drive head 96) eventually brings the shoulder 94 of the bolt 90 into engagement with the shoulder of the plain bore 86. Continued rotation of the bolt 90 clamps the end portions of the connector bodies 71,81 together. This configuration is shown in FIG. 8.

Once the torque exerted on the bolt 90 exceeds a predetermined limit, the bolt 90 shears at the base of the neck, preventing further rotation of the bolt 90, and hence preventing the application of excessive force. The dimensions of the bolt 90 are such that after the drive head 96 has sheared off, the tip of the shank 92 lies substantially flush with the external surface of the connector body 71 of the first connector 70 and the upper surface of the head 96 lies substantially flush with the upper surface of the external surface of the connector body 81 of the second connector 80.

1-32. (canceled)

33. An electrical connector, comprising:
a connector body defining a socket for receiving an electrical conductor;
a fastener mounted within the socket and engaged with a thread of an internal surface of the connector body so that rotation of the fastener relative to the connector body along a longitudinal axis of the socket causes movement of the fastener between a first position in which the socket is able to receive the electrical conductor and a second position in which the fastener fastens the electrical conductor within the socket; and
a drive component rotatably mounted to the connector body and configured to engage the fastener such that rotation of the drive component with respect to the connector body causes rotation movement of the fastener between the first position and the second position.

34. An electrical connector according to claim 33, wherein the drive component is rotatably mounted to the connector body with cooperating formations on the drive component and the connector body.

35. An electrical connector according to claim 34, wherein a part of the drive component extends into the socket comprises formations that cooperate with formations on the internal wall of the socket.

36. An electrical connector according to claim 35, wherein the drive component is rotatably mounted to the connector by with a projection on an external surface of the drive component that cooperates with an annular groove formed in an internal surface of the connector body.

37. An electrical connector according to claim 33, wherein a non-circular projection of the drive component is configured to engages with a complementarily shaped recess of the fastener.

38. An electrical connector according to claim 33, wherein the connector body comprises a generally smooth external shape that is substantially free from protrusions and sharp edges when the conductor is fastened within the socket.

39. An electrical connector according to claim 38, wherein the connector body comprises a generally circular external cross-sectional shape.

40. An electrical connector according to claim 33, wherein the connector body is adapted for engagement with a tool for rotational control of the connector body during fastening of the conductor within the socket.

41. An electrical connector according to claim 40, wherein the connector body comprises formations suitable for engagement with the tool.

42. An electrical connector according to claim 41, wherein the part of the connector body that carries the formations is removable from the connector body after the conductor has been fastened within the socket.

43. An electrical connector according to claim 42, wherein the formations are formed on a head configured to shear from the connector body when a pre-determined torque is applied to the head relative to the connector body.

44. An electrical connector according to claim 33, wherein the socket is configured to deform the fastener into engagement with the electrical conductor as the fastener moves from the first position to the second position, thereby fastening the electrical conductor within the socket.

45. An electrical connector according to claim 44, wherein the socket comprises a region of reduced cross-sectional area that acts to deform the fastener.

46. An electrical connector according to claim 45, wherein the socket comprises an outer portion and an inner portion having a reduced cross-sectional area relative to the outer portion.

47. An electrical connector according to claim 46, wherein a cavity that is defined by an interior surface of the connector body that defines the inner portion of the socket and further defined by the electrical conductor, receives at least a portion of the fastener thereby fastening the electrical conductor within the socket by frictional engagement.

48. An electrical connector according to claim 47, wherein the inner and outer portions of the socket each have a constant cross-sectional area and the socket includes a tapered shoulder between the inner and outer portions of the socket.

49. An electrical connector according to claim 48, wherein the fastener decreases in thickness as it extends in the direction of the inner portion of the socket.

50. An electrical connector according to claim 33, wherein the fastener extends around a circumference of the electrical conductor when the electrical conductor is fastened within the socket.

51. An electrical connector according to claim 33, wherein the electrical connector is a jointing connector for connecting two conductors together and comprises two or more sockets that are each adapted to have an electrical conductor fastened within the sockets.

52. A method of fastening an electrical conductor within a socket of an electrical connector, comprising the steps of:
providing an electrical connector comprising a connector body defining a socket for receiving an electrical conductor, a fastener mounted within the socket and engaged with a thread of an internal surface of the connector body so that rotation of the fastener relative to the connector body along a longitudinal axis of the socket causes movement of the fastener between a first position in which the socket is able to receive the electrical conductor and a second position in which the fastener fastens the electrical conductor within the socket, and a drive component rotatably mounted to the connector body and configured to engage the fastener such that rotation of the drive component with respect to the connector body causes rotation movement of the fastener between the first position and the second position;
inserting the electrical conductor into the socket; and
rotating the drive component relative to the connector body thereby causing the fastener to move along the longitudinal axis and thereby fastening the electrical conductor within the socket.
